(19) United States
(12) Patent Application Publication
(10) Pub. No.: US 2008/0131598 A1
(43) Pub. Date: Jun. 5, 2008

(54) Process of Ceramic Lever Strenthening

(76) Inventor: Igor Grigorovich Gumennyy, Kharkov (UA)

Correspondence Address: BEEM PATENT LAW FIRM, 53 W. JACKSON BLVD., SUITE 1352, CHICAGO, IL, 60604-3787, US

(21) Appl. No.: 11/943,274

(22) Filed: Nov. 20, 2007

(30) Foreign Application Priority Data
Nov. 30, 2006 (UA) U200612622

(51) Int. Cl. B05D 7/22

(52) U.S. Cl. 427/235; 427/230

(57) ABSTRACT

The process permits to strengthen a lever made of ceramic material. Ceramics is strong, but brittle, thus, in the course of lever operation it may undergo external mechanical forces, such as sudden impact, that generally cause cracks and spalling. After such damage ceramic pieces may separate from the ceramic support.

The utility proposes to strengthen a ceramic lever with a special glue coating made of one of series of thermoplastic glue melts and applied to the internal surface of ceramic lever cavity.

The solution has as its object to improve a ceramic lever strengthening process comprising application of glue coating made of a series of thermoplastic glue melts to the internal surface of a ceramic lever cavity according to which the glue coating undergoes thermal treatment at between about 80° C. and 180° C. before application to the internal surface of ceramic lever cavity.

This application claims the benefit of priority from Ukrainian patent application number u200612622, filed Nov. 30, 2006.

### BACKGROUND OF THE INVENTION

1. Field of the Invention

The present utility relates to a process of strengthening of ceramic devices used in food industry.

2. Description of the Related Art

Ceramic devices are used in many food applications both for manufacture of ceramic containers and miscellaneous appliances. The solution would improve the process of strengthening of a ceramic lever used in dispensers of beverages, such as beer. Beer dispenser comprises several special units that ensure supply of fluid and its temporary preservation. Beer is generally fed through a special mechanical tap, which comprises a valve and a small levering fixture. The levering fixture, or lever, serves to open and close such tap. Tap lever may be made from various food-compatible materials.

### DETAILED DESCRIPTION

The proposed process permits strengthening of a lever made of ceramic material. Ceramics is strong, but brittle, thus, in the course of lever operation it may undergo external mechanical forces, such as sudden impact, that generally cause cracks and spalling. After such mechanical damage large or small ceramic pieces may separate from the ceramic support and either get to beer or hurt operator's hand.

Ceramic articles have been used, for instance, in radio engineering for a long time, and some processes for strengthening are known. Ceramic or other materials used in radio engineering are often strengthened with various glues. Thus, “Ceramic Resistive Element and Method of its Manufacture” are known from patent of Russian Federation number 2211496 of 27.08.2003. It refers to electric and radio engineering and may be used for manufacture of wire resistors in automotive industry. Ceramic resistive element is a monolithic metal connection in ceramics obtained by joint high temperature firing without cracking of ceramics. Resistor metal with welded current branches is a basic support having two layers of ceramic insulation. The first layer is a coating of composite material on the basis of ceramics and/or glass, and/or glass cement, and/or inorganic glue/cement. The second layer has the form of ceramic body defining the dimensions and external configuration of the article. Another embodiment of this invention supposes the second layer in the form of a metal container having a metal basic support within coated with ceramics and/or glass, and/or glass cement, and/or inorganic glue/cement, whose thickness and configuration lie within the scope of metal container cavity. The method of its manufacture consists in formation of the second ceramic layer by, say, hot die-casting. After application of the first layer and subsequent drying the article is heated and simultaneously wetted in a thermoplastic compound melt consisting of the same components that the thermoplastic slip of the second layer. Then the layers are co-processed under temperature in excess of that necessary for complete burnout of binder, whereas the complete sintering of ceramics is not necessary. The result is efficient heat transfer from the resistor, high thermal and electric safety in operation and cheap manufacture.

Besides, “Method of Decorative Paper Impregnation” is known from patent of Russian Federation number 2226578 of 10.04.2004. Here in manufacture of decorative paper used in wear-resistant multi-layer floor coating, the paper is first wetted by impregnation with an amino resin, regulating the amount of resin with dosing rolls, then spray on the wetted paper a layer of amino acid in an abrasive-containing dispersion. Before spraying the dispersion is constantly circulated to prevent sedimentation of the abrasive matter. The dispersion comprises an amino resin, abrasive matter, silane glue, a flowability agent, wetting means, separating means and amine curing agent. The abrasive matter is silicon carbide or alumina in the form of corundum or a melt with particle size between about 60 and about 160 μm. The result consists in increased wear resistance of decorative multi-layer floor coating. In spite of the fact that in this process the material to be strengthened is not brittle, we suppose that here a material of scarce strength (paper) was strengthened by application of thermoplastic glue melt layer.

Therefore, we propose to apply a special glue made of some thermoplastic glue melts and applied to internal surface of ceramic lever cavity, in order to strengthen articles of this kind. Glue melts creating a special coating on the internal surface of ceramic layer have a synthetic rubber basis. The glue melt as per Ukrainian Technical Specification TY Y 24.6-31610030-008:2005 comprises a synthetic rubber, rosin, vaseline oil, wax. Melted glues are known to have a good adhesion to metals, plastics, ceramics, wood, leather, fabrics, etc. Glue connections resist mechanical loads (including stripping and impact), as well as fuels, motor oils, fungi. Thermal resistance of most glue connections lies within the range between about 80° C. and about 100° C., in some cases even between about 125° C. and about 150° C. Glue melts are used in manufacture of machinery and instrumentation, containers and packing, as well as in printing and wood processing.

In the same way metal plastic strips are strengthened according to patent of Russian Federation number 2290314 of 27.12.2006 “Process and Apparatus for Metal Plastic Strip Manufacture”. This process comprises stages of cleaning, chemical pretreatment of cleaned metal strip, drying of metal strip and joint feeding of metal and plastic strips to pressure rolls. The means for metal strip cleaning and formation of a single non-metal chemical coating is perchloroethylene, the metal strip being dipped into its solution. Then the strip is heated to 35° C. Gluing primer is applied onto upper side of metal strip as a binder. After that the metal strip is heated to 50° C. before connecting to plastic strip, which is coated from connection side with polyurethane glue, melt heated up to its melting point. To improve adhesion before connected metal and plastic strips the plastic strip has larger width than the metal one. After connection plastic strip is cut to become equal in width to metal strip. The apparatus for this process is also described.

The invention permits to obtain metal plastic strips capable of resisting hard formation of pipes with an internal seam without separation of polymer coating due to improved connection between metal and plastic strips, whereas the process and equipment are simplified.

The closest to the solution submitted herein is US patent application 20050139619 of 30.06.2005 whose applicant proposes a beverage dispensing lever made of porcelain or ceramics that is preliminarily filled with foam, preferably of expanded polyurethane, which after curing reproduces the outline of lever inside this lever, thus strengthening lever body from within and serving as an accumulator for small pieces of lever body material.

Foamed polyurethane is known to be thermo insulating and as a kind of foam plastic may be both rigid and elastic.

In solving a similar problem the above applicant proposes use of a material that is not compatible to foods. As our device is predestined for beer dispensers, the application of such materials as foamed polyurethane may hamper customers' health. Beer is known to be in a state of uncompleted chemical reaction—the process of alcoholic fermentation of barley malt wort, thus, foamed polyurethane would operate in an active medium. The US application 20050139619 never refers to any research substantiating application of foamed polyurethane-based materials interacting with food products. We suppose the application of foamed polyurethane and similar materials would be not only harmful, but also dangerous for the health of customers. Medical supervisory bodies must permit such usage.

The utility proposes to strengthen a ceramic lever with a special glue coating made of one of series of thermoplastic glue melts and applied to the internal surface of ceramic lever cavity.

Therefore, the solution has as its object to improve a ceramic lever strengthening process comprising application of glue coating made of a series of thermoplastic glue melts to the internal surface of a ceramic lever cavity according to which the glue coating undergoes thermal treatment at between about 80° C. and about 180° C. before application to the internal surface of ceramic lever cavity and after application to the internal surface of ceramic lever cavity forms a layer between about 0.5 mm and about 3 mm thick. Besides, the ceramic lever whose cavity is filled with melted glue coating is maintained in such condition for between about 10 and about 30 seconds at temperature between about 16° C. and about 26° C., and after draining of excessive liquid glue melt the ceramic lever is cooled for between about 5 and about 20 minutes.

The glue coating is generally made of a series of synthetic rubber-based thermoplastic glue melts. As the lever internal surface is porous, due to adhesive connection of glue melt film to internal porous surface of ceramic lever the strength of glue coating increases. Thus, the strength of glue connection depends on adhesion of glue melt to the internal surface of coating. In our case this means adhesion to lever internal surface as well as cohesion of glue film and the properties of material, ceramics in our case.

Thermal and temporal parameters as proposed in the process of ceramic lever strengthening are favorable for establishment of the best glue coating layer dimension, whereas the process parameters relating to curing of glue coating improve the quality of coating plasticity, strength, etc., thus permitting to reach the basic technological object of the whole manufacturing process.

Wetting of a surface with glue due to pouring of liquid glue to ceramic lever cavity is known to ensure maximum surface area of gluing. No special treatment of internal surface (mechanical cleaning, degreasing, roughing, etc.) is necessary. The glue coating is formed by way of glue layer cooling to a temperature under melting point of its basic components. As the melting point of glue film is sufficiently high and may never be reached under normal ceramic lever operation, we suppose that the submitted solution is quite acceptable for operation in food industry, namely, dispensers of liquids, such as beer.

The device comprises: ceramic support 1, glue coating 2.

The process is performed as follows.

The lever is enveloped with liquid thermoplastic melt heated to 120° C. It is applied to the internal level surface (non-glazed surface). To this end, the hollow lever is completely filled with liquid glue and maintained in this way for 15 seconds. During this time lever walls become coated with thermoplastic melt layer 1.5 mm thick, whereas the excessive glue pours back to the working container. The stable strong properties of glue appear immediately after cooling (10 minutes). The excessive glue (draining runs) is eliminated with a solvent. At the next stage a hub with ⅜-inch internal thread is attached to lower handle of the lever with epoxy resin. This hub helps to screw the lever to a tap that has an external thread of corresponding diameter.

In the following Examples the submitted parameters of thermal treatment, curing, cooling temperature and time are maintained.

### EXAMPLE 1

Thermoplastic glue melt is heated to 110° C.

Ceramic handle is completely filled with the melt and cured within 20 seconds.

Temperature of the environment is 18° C.

After draining of excessive glue 1 mm thick glue layer is established on the walls of ceramic handle.

The ceramic handle is cooled for 10 minutes.

### EXAMPLE 2

Thermoplastic glue melt is heated to 130° C.

Ceramic handle is completely filled with the melt and cured within 30 seconds.

Temperature of the environment is 24° C.

After draining of excessive glue 2 mm thick glue layer is established on the walls of ceramic handle.

The ceramic handle is cooled for 20 minutes.

Thus, the availability of glue coating wherein the chips of ceramic support stick leads to strengthening of lever ceramic form and prevents ceramic particles from getting to beer as well as accidental hurt of operator.

As seen from the above description, the proposed solution is new and applicable in industry. Ceramic lever strengthening with a thermoplastic glue melt would increase service life and operational safety of the ceramic article.

What is claimed is:

1. A process of ceramic lever strengthening comprising application of glue coating made of a series of thermoplastic glue melts to the internal surface of a ceramic lever cavity characterized in that the glue coating undergoes thermal treatment at 80-180° C. before application to the internal surface of ceramic lever cavity and after application to the internal surface of ceramic lever cavity forms a layer between about 0.5 mm and about 3 mm thick.

2. A process of ceramic lever strengthening according to claim 1 characterized in that the ceramic lever whose cavity is filled with melted glue coating is maintained in such condition for between about 10 seconds to about 30 seconds at temperature between about 16° C. and about 26° C.

3. A process of ceramic lever strengthening according to claim 1 characterized in that after draining of excessive liquid glue melt the ceramic lever is cooled for between about 5 minutes and about 20 minutes.
